(19) United States
(12) Patent Application Publication
(10) Pub. No.: US 2009/0001782 A1
(43) Pub. Date: Jan. 1, 2009

(54) Stepless adjustable seat post assembly

(76) Inventor: A. P. Lin, Chang Hwa City (TW)

Correspondence Address: CHARLES E. BAXLEY, ESQUIRE, 90 JOHN STREET, SUITE 309, NEW YORK, NY, 10038, US

(21) Appl. No.: 11/150,962

(22) Filed: Jun. 13, 2005

(51) Int. Cl. B62J 1/00

(52) U.S. Cl. 297/215.15

(57) ABSTRACT

A stepless adjustable seat post assembly comprises: a post provided at its an end with a passage, an annular inclined surface is formed at either end of the passage, on the annular inclined surface is formed an annular shoulder; two elastic members disposed at the annular shoulder of the post; two clamping members each includes an annular abutting surface and a press surface, and the two clamping members are disposed at both ends of the passage of the post; and an adjustment assembly is inserted through the two clamping members, the two elastic members, and the passage of the post. By adjusting the adjustment assembly, the two clamping will be caused to clamp or not to clamp the post.

### FIELD OF THE INVENTION

The present invention relates to a seat post assembly for a bicycle, and more particularly to a stepless adjustable seat post assembly for a bicycle.

### DESCRIPTION OF THE PRIOR ARTS

Conventionally, a bicycle seat is positioned to the seat post through a positioning portion at bottom of the seat, and once fixed, the bicycle seat cannot be adjusted to change angles relative to the seat post according to needs. Therefore, an adjustable seat post assembly was made, as shown in FIGS. 1 and 2, which comprises a post 11; a pair of clamping members 12 for clamping the post 11; a pair of gripping members 13 disposed outside the pair of clamping members 12; a spring 14 inserted through the post 11, the clamping members 12 and the gripping members 13; and an adjusting member 15 provided for adjusting the abovementioned respective components. A seat (not shown) is adjustably positioned between the adjusting member 15 and the gripping members 13.

However, this adjustable seat post assembly is difficult to be assembled, since in assembly, both the elastic force of the spring 14 and the direction of the clamping members 12 should be taken into account in order to clamp the seat appropriately.

The present invention has arisen to mitigate and/or obviate the afore-described disadvantages.

### SUMMARY OF THE INVENTION

The primary objective of the present invention is to provide a stepless adjustable seat post assembly for a bicycle that can be assembled more easily.

A stepless adjustable seat post assembly provided in accordance with the present invention comprises: a post provided at its an end thereof with a passage vertical to an axis of the post, an annular inclined surface being formed at either end of the passage and inclined toward a center of the passage, at an inner edge of the annular inclined surface is formed an annular shoulder; two elastic members disposed at the annular shoulder of the post; two clamping members each provided with an abutting portion, the abutting portion includes an annular abutting surface and a press surface, and the two clamping members are disposed at both ends of the passage of the post in such a manner that the annular abutting surface abuts against the annular inclined surface of the post, and the press surface abuts against the elastic members; and an adjustment assembly inserted through the two clamping members, the two elastic members, and the passage of the post, by adjusting the adjustment assembly, the two clamping will be caused to clamp and release the post.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional adjustable seat post assembly for a bicycle;

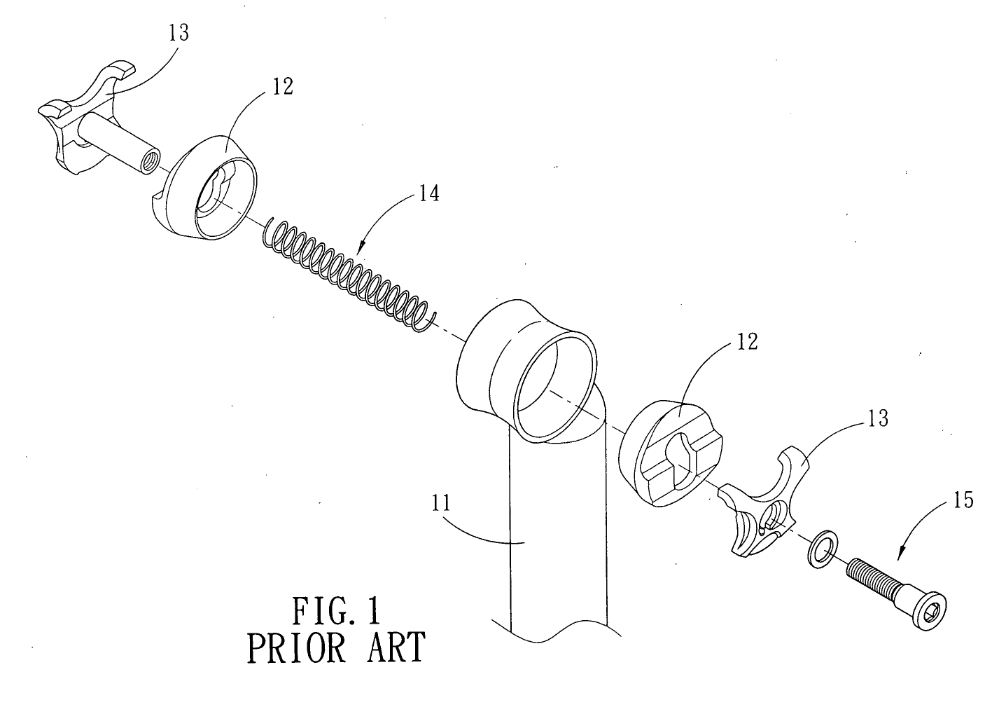

FIG. 2 is assembly view of the conventional adjustable seat post assembly for a bicycle;

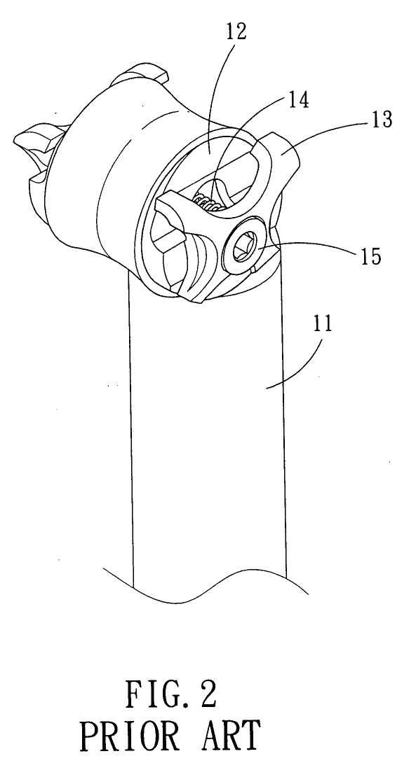

FIG. 3 is an exploded view of a stepless adjustable seat post assembly in accordance with a first embodiment of the present invention;

FIG. 4 is a perspective assembly view of the stepless adjustable seat post assembly in accordance with the first embodiment of the present invention;

FIG. 5 is a cross sectional assembly view of the stepless adjustable seat post assembly in accordance with the first embodiment of the present invention;

FIG. 6 is an illustrative view in which the adjustment assembly is unscrewed;

FIG. 7 shows a before and after adjustment state of the bicycle seat;

FIG. 8 is an exploded view of a stepless adjustable seat post assembly in accordance with a second embodiment of the present invention;

FIG. 9 is a perspective assembly view of the stepless adjustable seat post assembly in accordance with the second embodiment of the present invention.

### DETAILED DESCRIPTION OF THE PREFERRED EMBODIMENTS

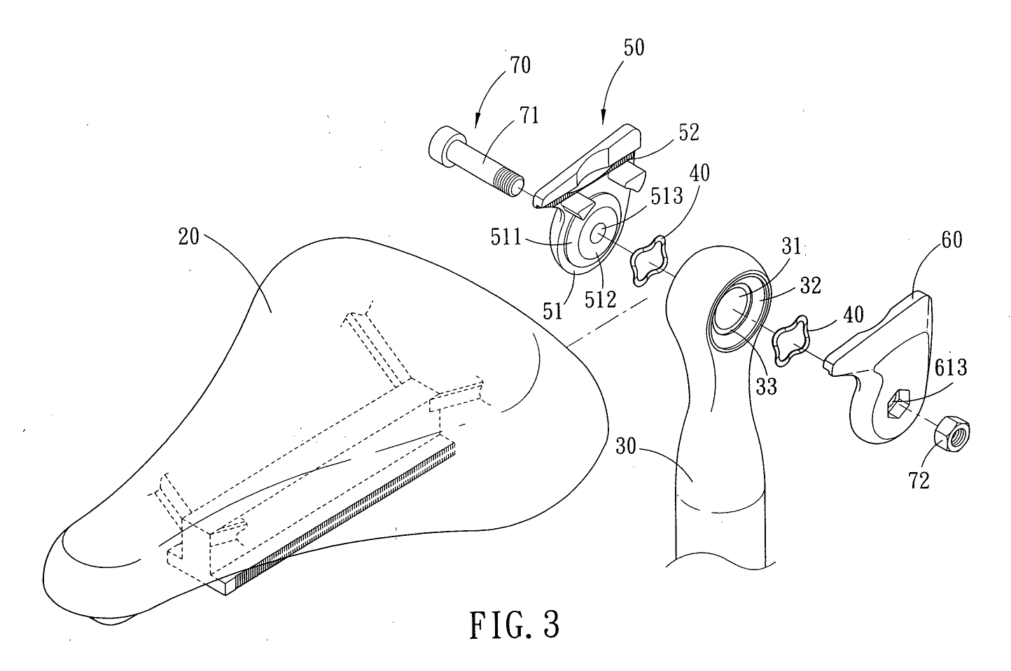

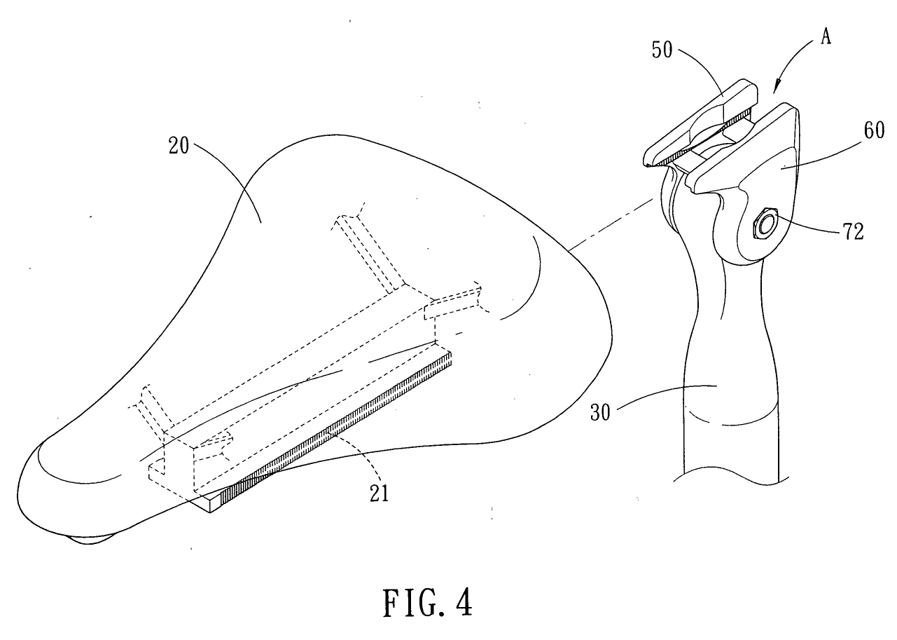

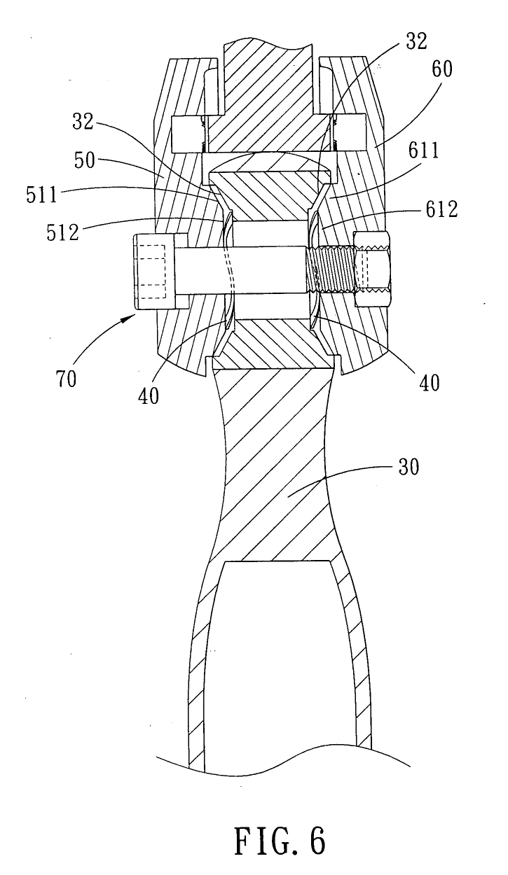

Referring to FIGS. 3-6, a stepless adjustable seat post assembly provided for positioning a bicycle seat 20 is shown and comprises: a post 30, a pair of elastic members 40, two clamping members 50 and 60, and an adjustment assembly 70.

The post 30 is provided at an end thereof with a passage 31, both edges of the passage 31 is inclined inward toward the center thereof, forming an annular inclined surface 32 circling the central hole of the passage 31. At the inner edge of the annular inclined surface 32 is formed an annular shoulder 33.

Each of the elastic members 40 is an elastic wave washer to be disposed on the shoulder 33 of the post 30. The elastic members 40 also provide rough contact surfaces to increase surface friction preventing clamping members 50 and 60 slipped when external torque is applied.

The two clamping members 50 and 60 each have a protrusive abutting portion 51 and 61 that each includes an annular abutting surface 511 and 611 and a press surface 512 and 612. At the center of the press surfaces 512 and 612 is formed a through hole 513 and 613. At the upper end of the abutting portions 51 and 61 is formed a clamping groove 52 and 62. The clamping members 50 and 60 are disposed at either end of the passage 31 of the post 30 in such a manner that the abutting portions 51 and 61 is inserted in the passage 31, the annular abutting surfaces 511 and 611 abut against the annular inclined surfaces 32, and the press surfaces 512 and 612 press against the elastic members 40. Furthermore, after the clamping members 50 and 60 are disposed at both ends of the passage 31 of the post 30, the clamping grooves 52 and 62 of the clamping members 50 and 60 will cooperate with each other to define a clamping space A theretween for griping a positioning portion 21 of the seat 20.

The adjustment assembly 70 comprises a bolt 71 and a screw nut 72. The bolt 71, after passing through the through holes 513 and 613 of the clamping member 50 and 60, the elastic members 40 and the passage 31 of the post 30, is screwed with the screw nut 72. By adjusting the adjustment assembly 70, the clamping members 50 and 60 can be adjusted to clamp or release the post 30.

The user only needs to assemble the two elastic members 40 and the clamping members 50 and 60 sequentially into and out of the passage 31 of the post 30, and then to insert the bolt 71 through the clamping member 50 and 60, the elastic members 40 and the post 30, and finally screw it with the screw nut 72. Therefore, the present invention is much simplified in structure as compared to the conventional art, so that the seat post assembly can be assembled more easily and quickly.

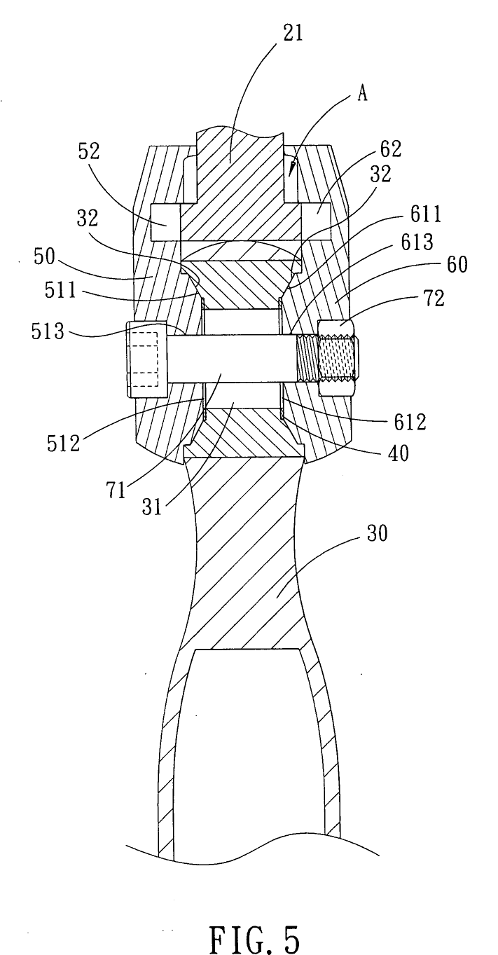

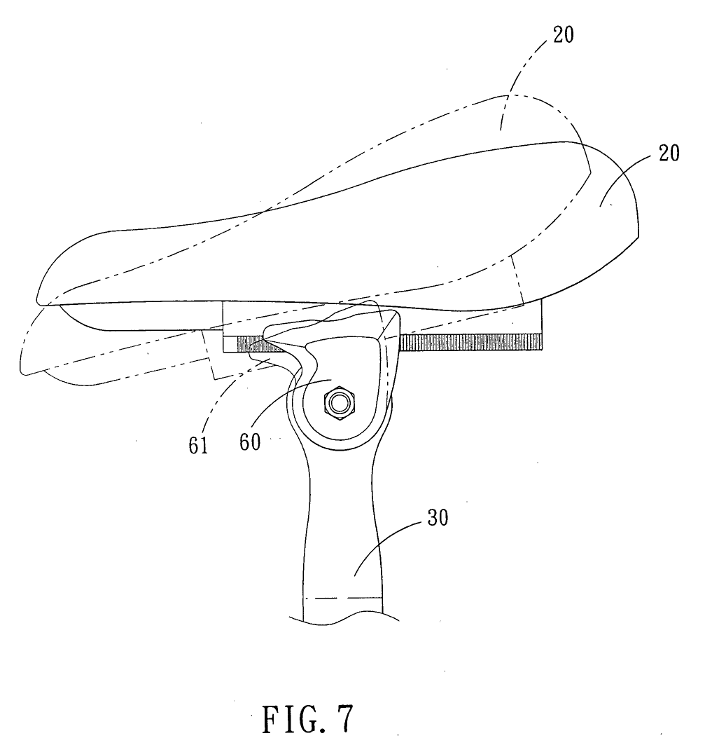

For a better understanding of the operation of the present invention, references should be made to FIGS. 5, 6 and 7. By loosening the adjustment assembly 70, the annular abutting surfaces 511 and 611 of the clamping members 50 and 60 will be disengaged from the annular inclined surface 32 of the post 30, and the press surfaces 512 and 612 will not press against the elastic members 40 anymore. At this moment, the two clamping members 50 and 60 can be rotated to a desired angle relative to the horizontal, and the seat 20 between the clamping members 50 and 60 is also adjusted along with the rotation of the clamping members, so that the angle of the seat 20 relative to the seat post is changed. After adjusting the seat to a desired angle, the user can screw the adjustment assembly 70 tight to fix the seat 20. Therefore, the seat post assembly has a stepless adjustment function.

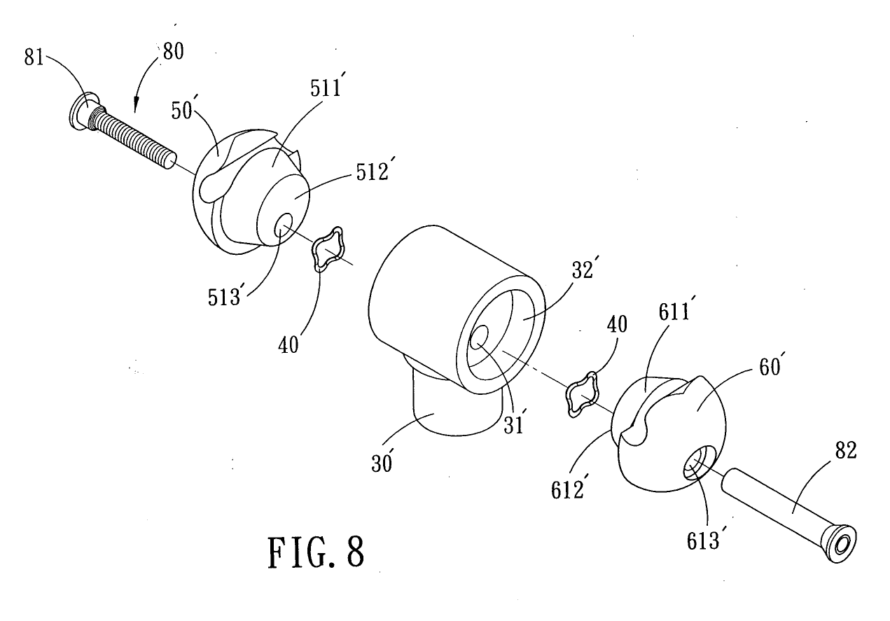

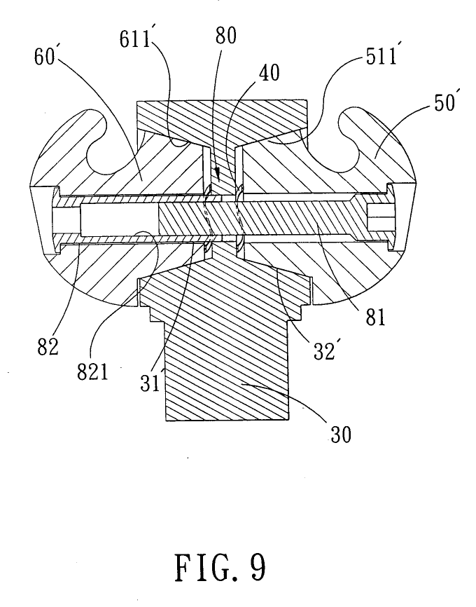

Referring finally to FIGS. 8 and 9, a stepless adjustable seat post assembly in accordance with a second embodiment of the present invention comprises:

A post 30′ is provided at an end with a passage 31′ that is vertical to the axis of the post 30′, and both edges of the passage 31′ is inclined inward toward the center thereof, forming an annular inclined surface 32′ circling the central hole of the passage 31′.

Two elastic members 40 each is an elastic wave washer to be disposed outside the passage 31′ of the post 30′.

Two clamping members 50′ and 60′ each includes an annular abutting surface 511′ and 611′ for abutting against the annular inclined surface 32′ and a press surface 512′ and 612′ for pushing against the elastic members 40, and is defined with a through hole 511′ and 611′.

An adjustment assembly 80 includes a bolt 81 and a hollow screw rod 82 provided with inner threads 821 for meshing with the bolt 81. The bolt 81 and the hollow screw rod 82 are connected together within the passage 31′ of the post 30′ and can be screwed and unscrewed relative to each other, after passing through the through holes 513′ and 613′ of the two clamping members 50′ and 60′ and the elastic members 40.

The annular inclined surfaces 32′ of the passage 31′ are employed to abut against the annular abutting surfaces 511′ and 611′ of the clamping members 50′ and 60′, and by screwing and unscrewing the adjustment assembly 80, the clamping members 50′ and 60's can be adjusted to and positioned at a desired angle relative to the horizontal, and consequently the seat is adjusted and positioned at the desired angle after adjustment of the clamping members.

While we have shown and described various embodiments in accordance with the present invention, it should be clear to those skilled in the art that further embodiments may be made without departing from the scope of the present invention.

1. A stepless adjustable seat post assembly comprising: a post provided at an end thereof with a passage, an annular inclined surface being formed at either end of the passage and inclined toward a center of the passage, at an inner edge of the annular inclined surface formed an annular shoulder;
two elastic members disposed at the annular shoulder of the post;
two clamping members each provided with a protrusive abutting portion, wherein the protrusive abutting portion includes an annular abutting surface and a press surface, and the two clamping members are disposed at both ends of the passage of the post in such a manner that the annular abutting surface abuts against the annular inclined surface of the post, and the press surface pushes against the elastic members; and
an adjustment assembly inserted through the two clamping members, the two elastic members, and the passage of the post, by adjusting the adjustment assembly, the two clamping will be caused to clamp and release the post.

2. The stepless adjustable seat post assembly as claimed in claim 1, wherein both edges of the passage of the post are inclined inward toward the center of the passage, thus forming the annular inclined surface.

3. The stepless adjustable seat post assembly as claimed in claim 1, wherein the elastic members are an elastic wave washer.

4. The stepless adjustable seat post assembly as claimed in claim 1, wherein a clamping space provided for clamping the seat will be defined between the clamping members after the two clamping members are disposed at both ends of the passage of the post.

5. The stepless adjustable seat post assembly as claimed in claim 1, wherein the adjustment assembly includes a bolt and a screw nut, the bolt is screwed with the nut after passing through the two clamping members, the two elastic members and the post.

6. The stepless adjustable seat post assembly as claimed in claim 1, wherein the adjustment assembly includes a bolt and a hollow screw rod with inner threads to be meshed with the bolt, the bolt and the hollow screw rod, after passing through the two clamping members and the two elastic members, are connected within the passage of the post.
